(19) United States
(12) Patent Application Publication
(10) Pub. No.: US 2006/0070096 A1
(43) Pub. Date: Mar. 30, 2006

(54) Broadcasting receiving apparatus and broadcasting receiving method

(76) Inventor: Hiroyuki Nakano, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/235,204

(22) Filed: Sep. 27, 2005

(30) Foreign Application Priority Data
Sep. 27, 2004 (JP) 2004-280738

(51) Int. Cl. H04N 7/167

(52) U.S. Cl. 725/31; 380/210

(57) ABSTRACT

A broadcasting receiving apparatus includes a tuner to receive a broadcasting signal and output a reception signal selected therefrom, a demodulation portion to output a video audio signal by demodulating the reception signal from the tuner, an encryption portion to output an encrypted video audio signal by encrypting the video audio signal, a buffer portion to store one of the video audio signal from the demodulation portion and the encrypted video audio signal from the encryption portion, and a control portion to perform control in such a manner that, when the video audio signal needs to be encrypted in the encryption portion, the video audio signal is transferred in the form of first files each having a first capacity (m [KByte]), encrypted on a file-by-file basis in the encryption portion, and stored into a memory region in the buffer portion successively in units of the first capacity, and when the video audio signal need not be encrypted in the encryption portion, the video audio signal is transferred in the form of plural second files each having a second capacity (n [KByte], (m>n)) smaller than the first capacity on a file-by-file basis, and stored into the memory region in the buffer portion successively in units of the second capacity. It is thus possible to provide a receiving apparatus capable of preventing unauthorized copying of a video audio signal committed by tampering with flag information indicating the need for encryption.

### CROSS-REFERENCE TO RELATED APPLICATIONS

This application claims the benefit of priority from prior Japanese Patent Application No. 2004-280738, filed Sep. 27, 2004, the contents of which are herein incorporated by reference.

### BACKGROUND OF THE INVENTION

1. Field of the Invention

The present invention relates to a broadcasting receiving apparatus, such as a TV set furnished with a network function, and more particularly, to a broadcasting receiving apparatus and a broadcasting receiving method capable of evading eavesdropping of a video audio signal via a network.

2. Description of the Related Art

It is well known that digitalization of TV broadcasting is being promoted in recent years. For example, terrestrial digital broadcasting has launched in Japan in addition to satellite digital broadcasting, such as BS (Broadcasting Satellite) digital broadcasting and 110 CS (Communication Satellite) digital broadcasting.

A digital broadcasting receiving apparatus to receive such digital TV broadcasting makes it easier for the user to process received information by recording, playing back, searching, and managing the contents information. The digital broadcasting also makes electronic program information available to the user due to its ability to handle video and audio information in the form of a digital signal.

JP-A-2002-142163 discloses a technique for obtaining and using electronic program information from digital TV broadcasting. JP-A-2002-142163, however, fails to disclose how the user makes good use of the obtained digital contents via a network. Moreover, it does not disclose any countermeasure against a security problem, such as a risk of unauthorized use of data by a third party when the digital contents are transmitted over a network.

### SUMMARY OF THE INVENTION

An object of the invention is therefore to address such a security problem by providing a receiving apparatus and method of prohibiting unauthorized copying of a video audio signal.

The invention can prevent unauthorized copying.

### BRIEF DESCRIPTION OF THE DRAWINGS

FIG. 1 schematically illustrates one example of a digital TV broadcasting receiving apparatus according to one embodiment of the invention and a network system for the digital TV broadcasting receiving apparatus;

FIG. 2 is a block diagram showing one example of the digital TV broadcasting receiving apparatus according to one embodiment of the invention;

FIG. 3 is a block diagram showing one example of a remote controller of the digital TV broadcasting receiving apparatus according to one embodiment of the invention;

FIG. 4 is a flowchart detailing one example of a content transfer process by the digital TV broadcasting receiving apparatus according to one embodiment of the invention; and

FIG. 5 describes one example of a transfer process by the digital TV broadcasting receiving apparatus according to one embodiment of the invention.

### DESCRIPTION OF THE PREFERRED EMBODIMENT

One exemplary embodiment of the invention will now be described in detail with reference to the accompanying drawings.

<TV Set Furnished with Network Function>

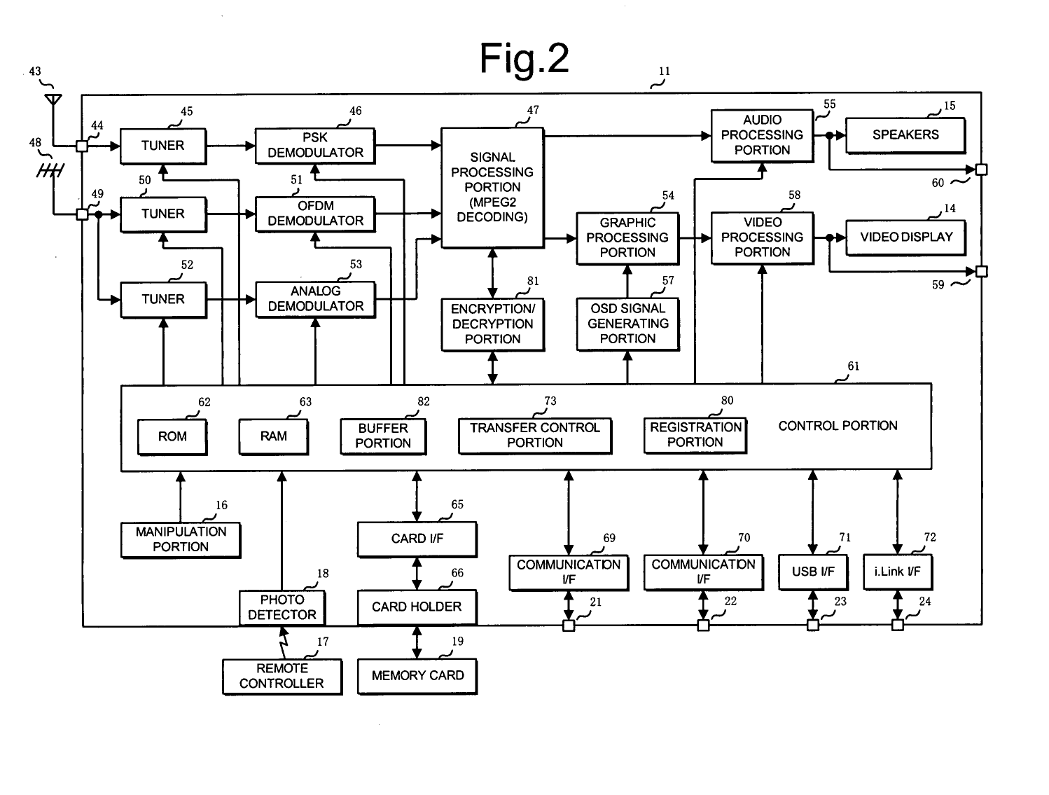

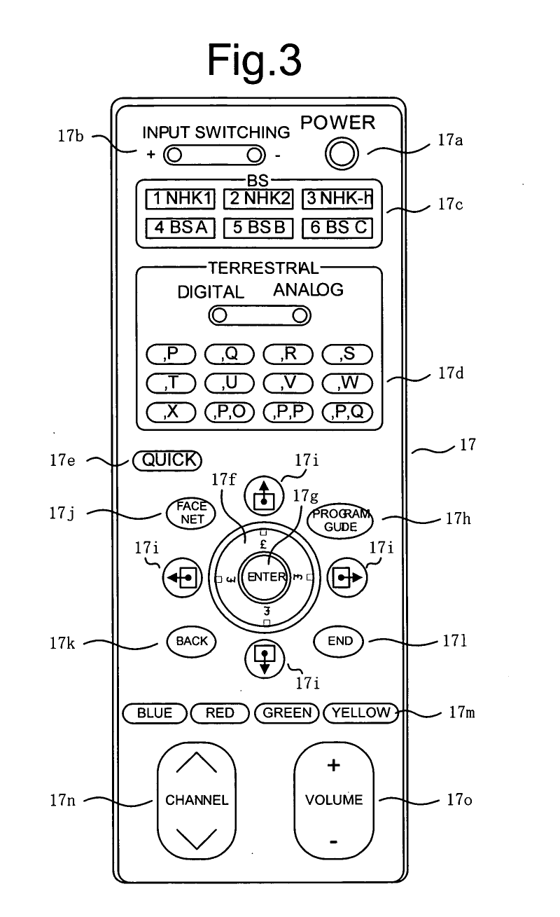

One example of a TV set furnished with a network function of the invention will be described first with reference to the drawings. FIG. 2 is a block diagram showing one example of a digital TV broadcasting receiving apparatus according to one embodiment of the invention. FIG. 3 is a block diagram showing one example of a remote controller of the digital TV broadcasting receiving apparatus according to one embodiment of the invention.

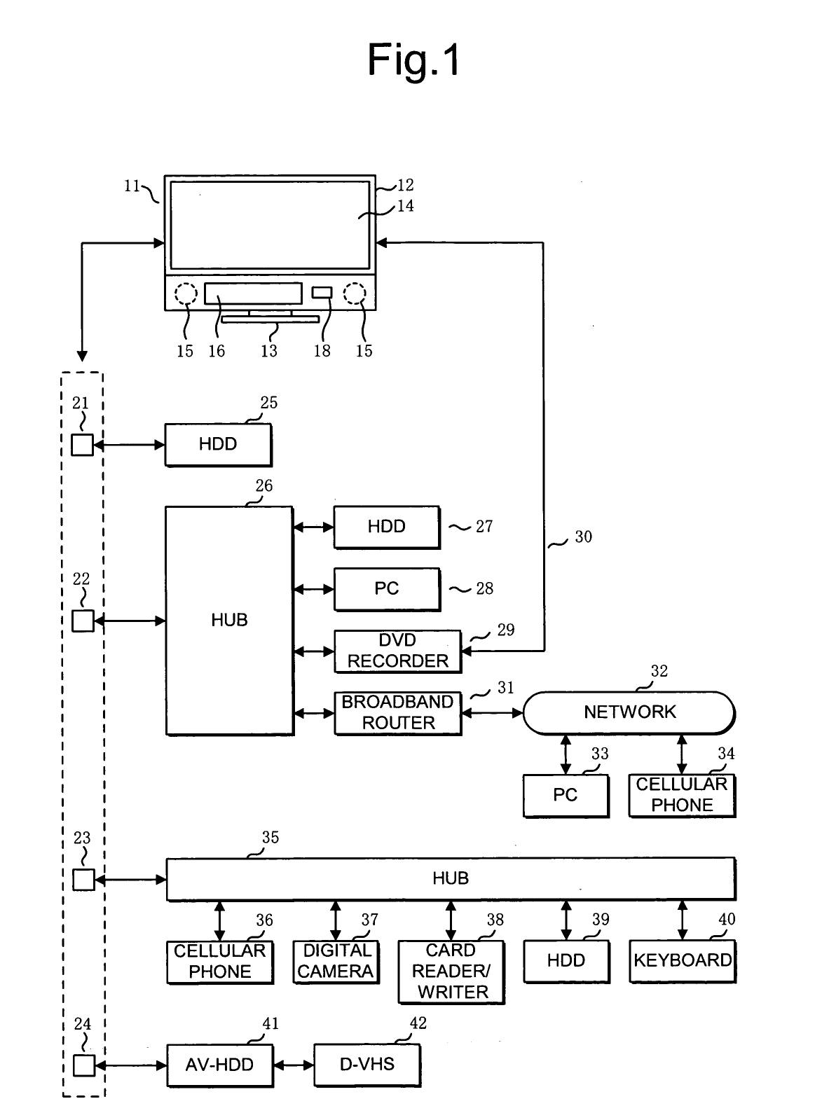

As shown in FIG. 1, a digital TV broadcasting receiving apparatus 11 includes a thin cabinet 12 and a stand 13 to support the cabinet 12 in an upright standing position. The cabinet 12 is provided with a flat-panel type video display 14 including, for example, a liquid crystal display panel, speakers 15, a manipulation portion 16, a photo detector 18 to receive manipulation information sent from a remote controller 17 (Not shown in FIG. 1), etc.

In addition, a memory card 19 (Not shown in FIG. 1), such as a memory card including an SD (Secure Digital) memory card, an MMC (Multimedia Card), and a memory stick, or such as a memory card (IC card) having recorded contract information or the like, can be inserted into the digital TV broadcasting receiving apparatus 11 in a removable manner. Information of programs, pictures, or text information is recoded in or played back from the memory card 19.

Further, the digital TV broadcasting receiving apparatus 11 may be provided with a first LAN (Local Area Network) terminal 21, a second LAN terminal 22, a USB (Universal Serial Bus) terminal 23, and an i.Link terminal 24.

The first LAN terminal 21 is used as a LAN-compatible HDD dedicated port to record/playback information in/out of a LAN-compatible HDD 25, which is a linked-NAS (Network Attached Storage), by Ethernet (registered trademark).

By providing the first LAN terminal 21 as a LAN-compatible HDD dedicated port in this manner, it is possible to reliably record information of a program into the HDD 25 at a high-definition image quality without being affected by other network environments and network use conditions.

The second LAN terminal 22 is used as a general LAN-compatible port by Ethernet (registered trademark) and is connected to devices, such as a LAN-compatible HDD 27, a PC (Personal Computer) 28, and a DVD (Digital Versatile Disk) recorder 29 equipped with an internal HDD, via a hub 26 to enable information transmission to and from these devices.

Because the digital information transmitted via the second LAN terminal 22 is only the control signal. Thus, it is necessary to provide a dedicated analog transmission channel 30 for the DVD recorder 29 to enable transmission of analog video and audio information with the digital TV broadcasting receiving apparatus 11.

The second LAN terminal 22 may also be connected to a network 32, such as the Internet, via a broadband router 31 connected to the hub 26, and is used to enable information transmission with a PC 33 and a cellular phone 34 via the network 32.

The USB terminal 23 is used as a general USB-compatible port and may be connected to USB devices, such as a cellular phone 36, a digital camera 37, a card reader/writer 38 corresponding to a memory card, an HDD 39, and a keyboard 40 via a hub 35 to transmit information to and from these USB devices.

The i.Link terminal 24 may be connected, for example, to an AV-HDD 41 and a D (Digital)-VHS (Video Home System) 42 in series to transmit information to and from these devices.

FIG. 2 shows one embodiment of a major signal processing system in the digital TV broadcasting receiving apparatus 11. To be more specific, a satellite digital TV broadcasting signal received at a BS/CS digital broadcasting receiving antenna 43 is supplied to a tuner 45 for satellite digital broadcasting via an input terminal 44, and a broadcasting signal on a desired channel is selected therein.

The broadcasting signal selected in the tuner 45 is supplied to a PSK (Phase Shift Keying) demodulator 46 to be demodulated to digital video signals and audio signals, which are then outputted to a signal processing portion 47.

Also, as shown in FIG. 2, a terrestrial digital TV broadcasting signal received at a terrestrial broadcasting receiving antenna 48 is supplied to a tuner 50 for terrestrial digital broadcasting via an input terminal 49, and a broadcasting signal on a desired channel is selected therein.

The broadcasting signal selected in the tuner 50 is supplied to an OFDM (Orthogonal Frequency Division Multiplexing) demodulator 51 to be demodulated to a digital video signal and an audio signal, which are then outputted to the signal processing portion 47.

A terrestrial analog TV broadcasting signal received at the terrestrial broadcasting receiving antenna 48 is supplied to a tuner 52 for terrestrial analog broadcasting via the input terminal 49, and a broadcasting signal on a desired channel is selected therein. The broadcasting signal selected in the tuner 52 is supplied to an analog demodulator 53 to be demodulated to analog video signal and audio signal, which are then outputted to the signal processing portion 47.

As shown in FIG. 2, the signal processing portion 47 selectively applies predetermined digital signal processing, for example, MPEG2 decoding processing, to the digital video signal and audio signal supplied from the PSK demodulator 46 and the OFDM demodulator 51. The signals are then outputted to a graphic processing portion 54 and an audio processing portion 55.

The graphic processing portion 54 may be furnished with a function of superimposing an OSD (On Screen Display) signal, which is generated in an OSD signal generating portion 57, on the digital video signal supplied from the signal processing portion 47, and thereby outputs the resulting signal. The graphic processing portion 54 is able to output an output video signal from the signal processing portion 47 and an output OSD signal from the OSD signal processing portion 57 selectively, or to output these two outputs by combining them in such a manner that each forms the half of an image.

The digital video signal outputted from the graphic processing portion 54 is then supplied to a video processing portion 58. The video processing portion 58 converts the input digital video signal to an analog video signal in a format that can be displayed on the video display 14. Thereafter, the analog video signal is outputted to the video display 14 for a video to be displayed thereon, and is also introduced to outside units via an output terminal 59.

The audio processing portion 55 converts the input digital audio signal to an analog audio signal in a format that can be played back by the speakers 15. Thereafter, the analog audio signal is outputted to the speakers 15 for a sound to be played, and is also introduced to the outside units via an output terminal 60.

All the operations of the digital TV broadcasting receiving apparatus 11, including various reception operations described above, are systematically controlled by a control portion 61. The control portion 61 includes an internal CPU (Central Processing Unit) or the like, and upon receipt of manipulation information from the manipulation portion 16 or upon receipt of manipulation information sent from the remote controller 17 via the photo detector 18, it controls respective portions to reflect the manipulation content.

In this case, the control portion 61 may mainly use a ROM (Read Only Memory) 62 having stored a control program run by the CPU, a RAM (Random Access Memory) 63 to provide a work area for the CPU, and a non-volatile memory 64 to store various kinds of setting information and control information.

Also, the control portion 61 may be connected to a card holder 66, in which the memory card 19 is inserted in a removable manner, via a card I/F (Interface) 65. This configuration enables information transmission between the control portion 61 and the memory card 19 inserted in the card holder 66, via the card I/F 65. Further, a second memory card (Not shown in FIG. 2) may be connected to the control portion 61 in a removable manner via unillustrated card I/F and card holder. This configuration enables information transmission between the control portion 61 and the second memory card.

In addition, the control portion 61 is connected to the first LAN terminal 21 via a communication I/F 69. This configuration enables information transmission between the control portion 61 and the LAN-compatible HDD 25 connected to the first LAN terminal 21, via the communication I/F 69. In this case, the control portion 61 may be furnished with a DHCP (Dynamic Host Configuration Protocol) server function, and therefore controls by assigning IP (internet Protocol) addresses to the LAN-compatible HDD 25 connected to the first LAN terminal 21.

The control portion 61 may also be connected to the second LAN terminal 22 via a communication I/F 70. This configuration enables information transmission between the control portion 61 and the respective devices (see FIG. 1) connected to the second LAN terminal 22, via the communication I/F 70.

The control portion 61 may also be connected to the USB terminal 23 via a USB I/F 71. This configuration enables information transmission between the control portion 61 and the respective devices (see FIG. 1) connected to the USB terminal 23, via the USB I/F 71.

The control portion 61 may further be connected to the i.Link terminal 24 via an i.Link I/F 72. This configuration enables information transmission between the control portion 61 and the respective devices (see FIG. 1) connected to the i.Link terminal 24, via the i.Link I/F 72.

As illustrated in the embodiment of FIG. 2, the digital TV broadcasting receiving apparatus 11 further includes a transfer control portion 73 to control transfer processing of a video audio signal, an encryption and decryption portion 81 to encrypt/decrypt a video audio signal outputted from the signal processing portion 47, and a buffer portion 82 included, for example, in the control portion 61 to receive an output from the encryption and decryption portion 81. The buffer portion 82 may be included in the interfaces 69 through 72, or may be provided independently. The control portion 61 may also include a registration portion 80 to register a record and playback device on the network that records and plays back information.

FIG. 3 shows one exemplary embodiment of a remote controller 17. The remote controller 17 may be provided with a power key 17a, an input switching key 17b, direct channel-selection keys 17c for satellite digital broadcasting, direct channel-selection keys 17d for terrestrial broadcasting, a quick key 17e, a cursor key 17f, an enter key 17g, a program guide key 17h, page switching keys 17i, a face net (navigation) key 17j, a back key 17k, an end key 171, color keys 17m for blue, red, green, and yellow, a channel up/down key 17n, a volume control key 17o, a menu key 17p, etc.

<Data Transfer Processing>

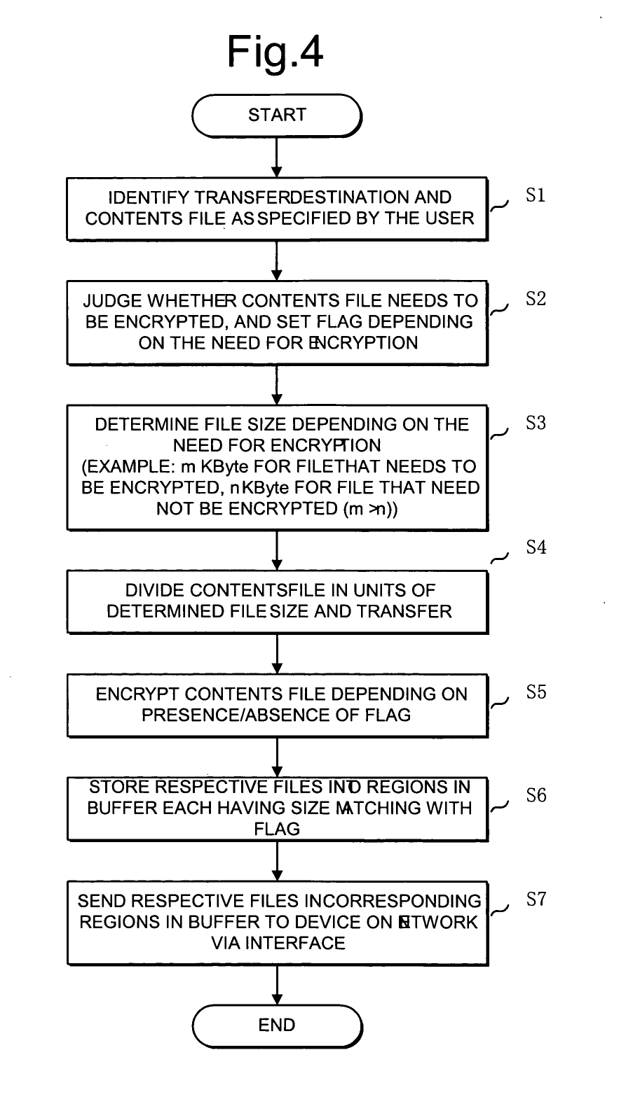

Data transfer processing by the digital TV broadcasting receiving apparatus to enhance the security against tampering of flag information by an unauthorized third party will now be described in detail with reference to the flowchart of FIG. 4.

Tampering of flag information in a file of a video audio signal in a digital device by an unauthorized third party has been a problem associated with digital devices, for example, the TV broadcasting receiving apparatus 11 or a hard disk recorder equipped with an internal tuner. One problem may be tempering of the flag information. The flag information indicating whether file data needs to be encrypted or not may be tampered at somewhere in a signal path of the digital device, for example, at the output stage of the signal processing portion 47, and re-written from “to be encrypted” to “not to be encrypted”. As a result, a video audio signal of digital broadcasting that should have been encrypted is thus transferred intact to the buffer portion 82 without being encrypted in the encryption and decryption portion 81.

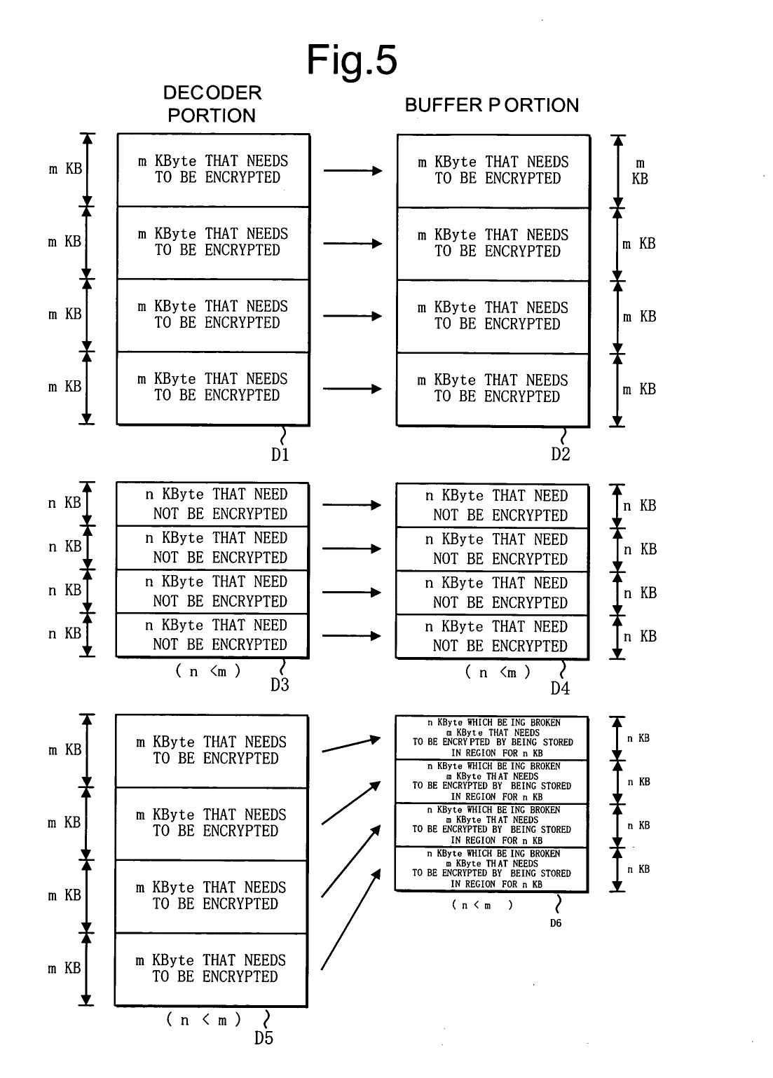

According to the data transfer processing of the invention, however, a video audio signal that needs to be encrypted is transferred in units of a first capacity (for example, m [KByte]), so that the signal is stored in the buffer portion 82 in units of the first capacity. Meanwhile, a video audio signal that need not be encrypted is transferred in units of a second capacity (for example, n [KByte], (m>n)), so that the signal is stored in the buffer portion 82 in units of the second capacity. Hence, should the flag information be tampered at somewhere in a signal path of the digital device and the signal evades encryption in the encryption and decryption portion 81, as shown in FIG. 5, the signal is transferred to the buffer portion 82 with a file size being set to the first capacity (for example, m [KByte]) and stored in units of the second capacity (for example, n [KByte], (m>n)). Hence, a part of the file is broken, and, for example, management information in the header portion or the like is broken, which makes it impossible to play back the signal normally. It is thus possible to prevent unauthorized copying by an unauthorized user.

Transfer of data D1 to data D2 in FIG. 5 is a case where a video audio signal that needs to be encrypted is transferred in units of the first capacity (for example, m [KByte]), and stored in the buffer portion also in units of the first capacity (for example, m [KByte]). Transfer of data D3 to data D4 in FIG. 5 is a case where a video audio signal that need not be encrypted is transferred in units of the second capacity (for example, n [KByte], (m>n)), and stored in the buffer portion also in units of the second capacity (for example, n [KByte] (m>n)). Further, transfer of data D5 to data D6 in FIG. 5 is a case where unauthorized copying can be prevented. More specifically, a video audio signal that needs to be encrypted is transferred in units of the first capacity (for example, m [KByte]), and the signal evades encryption in the encryption and decryption portion 81 because an unauthorized user succeeded in tampering with the flag information. However, because the unauthorized party failed to change the file size, the signal is stored in the buffer portion in units of the second capacity (for example, n [KByte], (m>n)). A part of each file having a capacity of m [KByte] is therefore broken, which makes it impossible to play back the signal normally. When the first capacity (for example, m [KByte]) takes a larger value than a value of the second capacity (for example n [KByte], (m>n)), the effect of preventing such an unauthorized use can be expected.

The data transfer processing of the invention may be performed as in the flowchart of FIG. 4 by program-based operations of the control portion 61 or the transfer control portion 73. That is, the user specifies a contents (video audio signal) file to be transferred and a destination device on the network (STEP S1). Then, whether the content file to be transferred needs to be encrypted is determined.

The criteria to determine the need for encryption when the contents file (video audio signal) is based on a broadcasting signal are as follows. It is suitable to encrypt the file based on a digital broadcasting signal. It is suitable not to encrypt a file based on an analog broadcasting signal. Likewise, it is suitable not to encrypt a file based on a video audio signal supplied from the outside in the form of an analog signal. It is suitable, however, to encrypt a file based on a video audio signal supplied from the outside in the form of an analog signal or an analog broadcasting signal when the video audio signal contains copy control information, such as CGMSA and Microvision.

When the control portion 61 or the transfer control portion 73 determines that the file needs to be encrypted, the video audio signal generates flag information indicating that the file is to be encrypted (STEP S2). The file size is then determined depending on the need for encryption, for example, m [KByte] for a file that needs to be encrypted and n [KByte] (m>n) for a file that need not be encrypted (STEP S3). The contents file is divided by the determined file size and transferred to the encryption and decryption portion 81 (STEP S4). It is suitable that each file contains flag information indicating whether the file needs to be encrypted as the head information. The encryption and decryption portion 81 encrypts the contents file according to the flag information (STEP S5). The encrypted or non-encrypted contents file is stored into the memory region in the buffer portion 82 included in the control portion 61 by the size matching with the flag information as is shown in FIG. 5 (STEP S6).

To be more specific, in the case of the transfer of data D3 to data D4 in FIG. 5, a video audio signal that need not be encrypted is transferred in units of the second capacity (for example, n [KByte] (m>n)), and stored in the buffer portion also in units of the second capacity (for example, n [KByte] (m>n)). In the case of the transfer of data D5 to data D6, a video audio signal that needs to be encrypted is transferred in units of the first capacity (for example, m [KByte]), and the signal evades encryption in the encryption and decryption portion 81 because an unauthorized user succeeded in tampering with the flag information. However, because the unauthorized party failed to change the file size, the signal is stored in the buffer portion in units of the second capacity (for example, n [KByte] (m>n)). A part of each file having a capacity of m [KByte] is therefore broken, and the signal is not played back normally. FIG. 5 shows a case where unauthorized copying processing can be prevented as has been described.

Subsequently, the control portion 61 or the transfer control portion 73 transmits the contents file to the predetermined device on the network by transmitting the respective files in the corresponding regions in the buffer memory 82 via the interfaces 69 through 72 (STEP S7). The predetermined device referred to herein means the recording device or the like specified by the user as the destination of the transferred file. It may be, however, the recording device registered in the registration portion 80 as the recording device for the digital TV broadcasting receiving apparatus 11.

As has been described, should an authorized user access the interior of the broadcasting receiving apparatus electronically and re-write the flag information successfully in trying to make an unauthorized copy of data in the broadcasting receiving apparatus, because the file size has been previously determined according to the need for encryption, the unauthorized user fails to change the file size itself in the broadcasting receiving apparatus.

When the flag information is re-written from “to be encrypted” to “not to be encrypted” under these circumstances, files each having a capacity of m [KByte] are written successively into the regions having a capacity of n [KByte] (m>n) in the buffer.

A part of each file is thus broken due to insufficient regions in the buffer, and for example, the header information in each file is broken, which makes it impossible to play back the signal normally.

Hence, should an unauthorized user succeed in re-writing the flag information, he is not able to play back the video audio signal normally. It is thus possible to prevent unauthorized copying, for example, of a video audio signal of digital broadcasting that should be protected by copyright.

Anyone skilled in the art can achieve the invention with reference to the embodiments above. However, various modifications will readily be apparent to anyone skilled in the art, and will be implemented to various embodiments without any inventive ability. It is therefore to be understood that the invention is not limited to the embodiments above and covers a broad scope unless it contradicts from the principles and novel features disclosed herein.

What is claimed is:

1. A broadcasting receiving apparatus, comprising:
a tuner configured to output a reception signal on a specific channel selected from a broadcasting signal;
a demodulation portion configured to output a video audio signal by demodulating the reception signal outputted from the tuner;
an encryption portion configured to output an encrypted video audio signal by encrypting the video audio signal outputted from the demodulation portion;
a buffer configured to store one of the video audio signal outputted from the demodulation portion and the encrypted video audio signal outputted from the encryption portion; and
a control portion configured to determine that, when the video audio signal from the demodulation portion needs to be encrypted in the encryption portion, the video audio signal is transferred in a form of first files, each having a first capacity, encrypted on a file-by-file basis in the encryption portion, and stored into a memory region in the buffer portion successively in units of the first capacity, and that when the video audio signal from the demodulation portion need not be encrypted in the encryption portion, the video audio signal is transferred in a form of plural second files, each having a second capacity smaller than the first capacity on the file-by-file basis, and stored into the memory region in the buffer portion successively in units of the second capacity.

2. The broadcasting receiving apparatus according to claim 1, further comprising:
a communication portion configured to communicate with an outside recording device via a network; and
a registration portion configured to register the recording device on the network so that the recording device records the video audio signal outputted from the demodulation portion,
wherein the control portion controls via the communication portion to record one of the video audio signal and the encrypted video audio signal stored in the buffer in the recording device on the network registered in the registration portion.

3. The broadcasting receiving apparatus according to claim 1, further comprising:
a decoder configured to decode the video audio signal demodulated by the demodulation portion; and
a supply portion configured to supply a decoded signal from the decoder to one of the encryption portion and the buffer.

4. The broadcasting receiving apparatus according to claim 1, further comprising:
a judging portion configured to determine whether the video audio signal demodulated by the demodulation portion needs to be encrypted; and
a flag appending portion configured to append flag information to the video audio signal depending on a judgment result of the judging portion.

5. The broadcasting receiving apparatus according to claim 4, wherein:
the judging portion determines that the video audio signal needs to be encrypted when the broadcasting signal received at the tuner is a digital broadcasting signal.

6. The broadcasting receiving apparatus according to claim 4, wherein:
the judging portion determines that the video audio signal needs to be encrypted when the broadcasting signal received at the tuner is an analog broadcasting signal containing copy control information.

7. The broadcasting receiving apparatus according to claim 4, wherein:
the judging portion determines whether the video audio signal needs to be encrypted on the basis of a setting condition pre-set by a user and a kind of the broadcasting signal received at the tuner.

8. A broadcasting receiving method, comprising:
outputting a reception signal on a specific channel selected from a broadcasting signal in a tuner;
outputting a video audio signal by demodulating the reception signal from the tuner in a demodulation portion;
outputting an encrypted video audio signal by encrypting the video audio signal in an encryption portion;
storing one of the video audio signal from the demodulation portion and the encrypted video audio signal from the encryption portion into a buffer; and
performing control by a control portion to determine that, when the video audio signal from the demodulation portion needs to be encrypted in the encryption portion, the video audio signal is transferred in a form of first files, each having a first capacity, encrypted on a file-by-file basis in the encryption portion, and stored into a memory region in the buffer successively in units of the first capacity, and that when the video audio signal from the demodulation portion need not be encrypted in the encryption portion, the video audio signal is transferred in the form of plural second files, each having a second capacity smaller than the first capacity on the file-by-file basis, and stored into a memory region in the buffer portion successively in units of the second capacity.

9. The broadcasting receiving method according to claim 8, further comprising:
communicating with an outside recording device via a network by a communication portion;
registering the recording device on the network in a registration portion so that the recording device records the video audio signal outputted from the demodulation portion; and
recording one of the video audio signal and the encrypted video audio signal stored in the buffer in the recording device on the network registered in the registration portion by the communication portion.

10. The broadcasting receiving method according to claim 8, further comprising:
decoding the video audio signal demodulated by the demodulation portion; and
supplying a decoded signal to one of the encryption portion and the buffer.

11. The broadcasting receiving method according to claim 8, further comprising:
determining whether the video audio signal demodulated by the demodulation portion needs to be encrypted; and
appending flag information to the video audio signal depending on a judgment result.

12. The broadcasting receiving method according to claim 11, further comprising:
determining that the video audio signal needs to be encrypted when the broadcasting signal received at the tuner is a digital broadcasting signal.

13. The broadcasting receiving method according to claim 11, further comprising:
determining that the video audio signal needs to be encrypted when the broadcasting signal received at the tuner is an analog broadcasting signal containing copy control information.

14. The broadcasting receiving method according to claim 11, further comprising:
determining whether the video audio signal needs to be encrypted on the basis of a setting condition pre-set by a user and a kind of the broadcasting signal received at the tuner.
